(19) United States
(12) Patent Application Publication
(10) Pub. No.: US 2025/0121459 A1
(43) Pub. Date: Apr. 17, 2025

(54) FLAME RECOGNITION METHOD, AND NUMERICAL CONTROL MACHINE AND NON-TRANSITORY COMPUTER-READABLE STORAGE MEDIUM

(71) Applicant: MAKEBLOCK CO., LTD., Shenzhen (CN)

(72) Inventors: YUANXIU ZHANG, Shenzhen (CN); LIJI DIAO, Shenzhen (CN); YUNCHAO ZHOU, Shenzhen (CN)

(21) Appl. No.: 18/983,817

(22) Filed: Dec. 17, 2024

Related U.S. Application Data
(63) Continuation-in-part of application No. PCT/CN2023/105165, filed on Jun. 30, 2023.

(30) Foreign Application Priority Data
Jul. 1, 2022 (CN) 202210765717.X

(51) Int. Cl. B23K 26/38; A62C 3/16; G06V 10/20; G06V 20/52

(52) U.S. Cl. CPC B23K 26/38; A62C 3/16; G06V 10/255; G06V 20/52; G06V 2201/06

(57) ABSTRACT

A flame recognition method includes: obtaining state information of the numerical control machine, where the state information indicates a condition of machining performed by the numerical control machine; obtaining flame information based on the state information, where the flame information indicates whether flames are generated in a machining process; and confirming whether exception handling of the numerical control machine is triggered according to the flame information.

### CROSS-REFERENCE TO RELATED APPLICATION

The present disclosure is a continuation in part of International Application No. PCT/CN2023/105165, filed Jun. 30, 2023, which claims priority to Chinese Patent Application No. 202210765717.X, filed Jul. 1, 2022, the entire disclosures of which are hereby incorporated herein by reference.

### TECHNICAL FIELD

The present disclosure relates to the technical field of machining, and more particularly, to a flame recognition method, a numerical control machine and a non-transitory computer-readable storage medium.

### BACKGROUND

Numerical control machines (such as computer numerical control (CNC) machines and laser machining equipment) generally implement machining on machined materials in cabins thereof. During the machining, there may be flames in the cabins of the numerical control machines due to high machining temperatures. If the flames are not found by users in time, a fire may occur. Therefore, the flames in the cabins of the numerical control machines need to be recognized.

### SUMMARY

There are provided a flame recognition method, a numerical control machine and a non-transitory computer-readable storage medium according to the present disclosure. The technical solution is as below:

According to a first aspect of an embodiment of the present disclosure, a flame recognition method for a numerical control machine is disclosed, including: obtaining state information of the numerical control machine, where the state information indicates a condition of machining performed by the numerical control machine; obtaining flame information based on the state information, where the flame information indicates whether flames are generated in a machining process; and confirming whether exception handling of the numerical control machine is triggered according to the flame information.

According to a second aspect of an embodiment of the present disclosure, a numerical control machine is disclosed, including a housing, a cover plate, a laser emitter, a track for driving the laser emitter to slide, a memory, and a processor, where the housing and the cover plate form a cabin in an enclosing manner; the laser emitter, a flame monitor, and the track are arranged inside the cabin; the memory is configured inside the housing and configured to store a readable instruction; and the processor in electrical signal connection with the memory reads the readable instruction stored in the memory, to perform the flame recognition method for a numerical control machine as described above.

According to a third aspect of an embodiment of the present disclosure, disclosed is a non-transitory computer-readable storage medium having a computer-readable instruction stored thereon, where the computer-readable instruction, when executed by a processor of a computer, causes the computer to perform the flame recognition method for a numerical control machine as described above.

It should be understood that the above general description and the following detailed description are only exemplary and are not intended to limit the present disclosure.

### BRIEF DESCRIPTION OF THE DRAWINGS

The accompanying drawings herein are incorporated into the specification, constitute a part of this specification, show the embodiments consistent with the present disclosure, and are used together with the specification to explain the principle of the present disclosure. Apparently, the accompanying drawings in the description below merely illustrate some embodiments of the present disclosure. Those of ordinary skill in the art may also derive other accompanying drawings from these accompanying drawings without creative efforts.

FIG. 1 shows a diagram of a system architecture to which a flame recognition method for a numerical control machine according to an embodiment of the present disclosure is applied.

FIG. 2 shows a flowchart of a flame recognition method for a numerical control machine according to an embodiment of the present disclosure.

FIG. 3 shows a schematic diagram of laser machining equipment according to an embodiment of the present disclosure.

FIG. 4 shows a flowchart of a flame recognition method for a numerical control machine according to another embodiment of the present disclosure.

FIG. 5 shows a flowchart of a flame recognition method for laser machining equipment according to another embodiment of the present disclosure.

FIG. 6 shows a flowchart of a flame recognition method for laser machining equipment according to another embodiment of the present disclosure.

FIG. 7 shows a flowchart of a flame recognition method for laser machining equipment according to another embodiment of the present disclosure.

FIG. 8 shows a diagram of a general architecture of a convolutional neural network according to an embodiment of the present disclosure.

FIG. 9 shows a flowchart of a flame recognition method for laser machining equipment according to another embodiment of the present disclosure.

FIG. 10 shows a flowchart of a flame recognition method for laser machining equipment according to another embodiment of the present disclosure.

FIG. 11 shows a flowchart of a flame recognition method for laser machining equipment according to another embodiment of the present disclosure.

FIG. 12 shows a block diagram of a flame recognition device for a numerical control machine according to an embodiment of the present disclosure.

FIG. 13 shows a hardware structure diagram of a flame recognition device for a numerical control machine according to an embodiment of the present disclosure.

FIG. 14 is a schematic diagram of hardware of the CNC machine according to an embodiment of the present application.

### DETAILED DESCRIPTION OF THE EMBODIMENTS

The exemplary embodiments will now be described more fully with reference to the accompanying drawings. However, the exemplary embodiments can be implemented in various forms and should not be understood to be limited to the examples elaborated herein; and rather, these exemplary embodiments are provided so that the description of the present disclosure will be more comprehensive and complete, and the concept of the exemplary embodiments will be fully conveyed to those skilled in the art. The accompanying drawings are only schematic illustrations of the present disclosure and are not necessarily drawn to scale. Like reference numerals in the figures denote identical or similar parts and thus repetitive descriptions thereof will be omitted.

In addition, the described features, structures or characteristics may be combined in any suitable way in one or more exemplary embodiments. In the description below, many specific details are provided to give a full understanding of the exemplary embodiments of the present disclosure. However, those skilled in the art will realize that the technical solution of the present disclosure may be practiced without one or more of the specific details, or other methods, components, steps, etc. may be employed. In other cases, the well-known structures, methods, implementations or operations are not shown or described in detail to avoid blurring various aspects of the present disclosure due to the secondary superseding the primary.

Some block diagrams shown in the accompanying drawings are functional entities and do not necessarily correspond to physically or logically independent entities. These functional entities may be implemented in a software form, in one or more hardware modules or integrated circuits, or in different networks and/or processor units and/or microcontroller units.

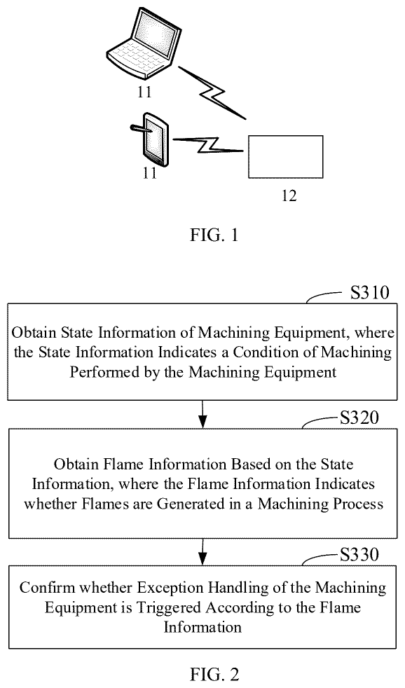

Reference is made to FIG. 1. FIG. 1 shows a diagram of a system architecture to which a flame recognition method for a numerical control machine according to an embodiment of the present disclosure is applied. The system architecture may include at least one external device 11 and a numerical control machine 12 for each external device 11. At least one production fixture can be provided for the numerical control machine to use, so as to form a customizable flame recognition function for a user. The external device 11 may be a tablet, a mobile phone, and a mobile Internet device capable of conducting wireless data communication. The numerical control machine 12 includes, but is not limited to, laser machining equipment, a three-dimensional (3D) printer, a computer numerical control (CNC) machine tool, etc.

In one possible embodiment of the present application, the numerical control machine includes a movable head. At least a part of a machined object is located in a machining space of the numerical control machine. The movable head is capable of transmitting electromagnetic energy to the machining space, to machine the machined object.

In one possible embodiment of the present application, the machining the machined object by the movable head includes:
generating a machining motion plan for the movable head based on a target machining graph; generating a preview image including the target machining graph for expected manufacturing on the machined object; and transmitting, by the numerical control machine, the electromagnetic energy to the machined object based on the machining motion plan, to change a material of the machined object.

In one possible embodiment of the present application, the numerical control machine includes a housing 90a (as shown in FIG. 1); the machining space is at least partially formed by the housing 90a; the movable head 50 (or laser emitter) is arranged in the housing 90a; and the housing 90a includes an openable blocking member (or cover plate 91) capable of weakening the transmission of the electromagnetic energy between the machining space and an exterior of the numerical control machine.

In one possible embodiment of the present application, the numerical control machine includes at least one camera arranged in the machining space and capable of capturing an image of at least a part of the machined object.

It should be understood that the number of external devices 11 in FIG. 1 is merely schematic. According to the requirements of implementation, there may be any number of external devices 11.

Some technical solutions of the embodiments of the present disclosure may be specifically implemented based on the system architecture as shown in FIG. 1 or variant architectures thereof.

Reference is made to FIG. 2. FIG. 2 shows a flowchart of a flame recognition method for a numerical control machine according to an embodiment of the present disclosure. The method may be applicable to the system architecture shown in FIG. 1, for example, may be specifically performed by the laser machining equipment. Certainly, the method may also be applicable to other system architectures, which is not limited in this embodiment.

As shown in FIG. 2, the method includes:
step S310: obtaining state information of the numerical control machine, where the state information indicates a condition of machining performed by the numerical control machine;
step S320: obtaining flame information based on the state information, where the flame information indicates whether flames are generated in a machining process; and
step S330: confirming whether exception handling of the numerical control machine is triggered according to the flame information.

The three steps are described in detail below.

In the step S310, the numerical control machine includes, but is not limited to, the laser machining equipment, the 3D printer, the CNC machine tool (an automatic machine tool installed with a program control system), etc. The state information of the numerical control machine is obtained by a flame monitor mounted in the numerical control machine, where the state information of the numerical control machine can indicate the condition of machining performed by the current numerical control machine.

In the step S320, a calculation is performed according to the obtained state information of the numerical control machine. Similarly, a calculation operation is performed by the flame monitor to obtain the information of the flame in the numerical control machine, where the flame information of the numerical control machine can indicate whether the flames are generated in the current numerical control machine, and a specific situation of the generated flames, such as an area and a quantity of the generated flames.

In the step S330, if the flame information indicates that no flames are generated in the machining process, the exception handling of the numerical control machine is not triggered; and if the flame information indicates that the flames are generated in the machining process, the flames are subjected to determination of a fire: if a fire probability of the flames reaches a set threshold, the exception handling of the numerical control machine is triggered, or if a fire probability of the flames does not reach a set threshold, the exception handling of the numerical control machine is not triggered. In addition, a fire probability of each flame generated may be calculated. If a certain number of flames with high fire probabilities are generated, the exception handling of the numerical control machine is triggered, otherwise the exception handling is not triggered, which is not limited in this embodiment.

In another embodiment, the exception handling includes at least one of giving an alarm, pausing machining, reducing output of electromagnetic energy, blocking emission of the electromagnetic energy, locking a cover of the machine, stopping an air pump device, and reducing heat output of one or more heating components.

Further, the alarm may include making a sound in linkage with a buzzer, sending a message or an email to a designated person in charge, etc. The pausing machining includes cutting off a power supply to make the numerical control machine stop machining, and making the numerical control machine stop machining through operation control when the power supply is connected, where the operation control includes artificial control, and automatic control of the machining equipment to stop machining when preset machining stop conditions are met. The reducing output of electromagnetic energy may include reducing emission power of the electromagnetic energy. Locking the cover of the machine can prevent fire spread from endangering other property safety. Stopping the air pump device can stop blowing to effectively prevent the risk of combustion supporting. Reducing the heat output of the one or more heating components can prevent combustion supporting on the fire.

From the above, it can be seen that the flames can be effectively prevented from being further transformed into the fire in various exception handling ways for the numerical control machine according to an embodiment of the present disclosure.

The process of executing the flame recognition method is illustrated using the laser machining equipment as an example in the numerical control machine below.

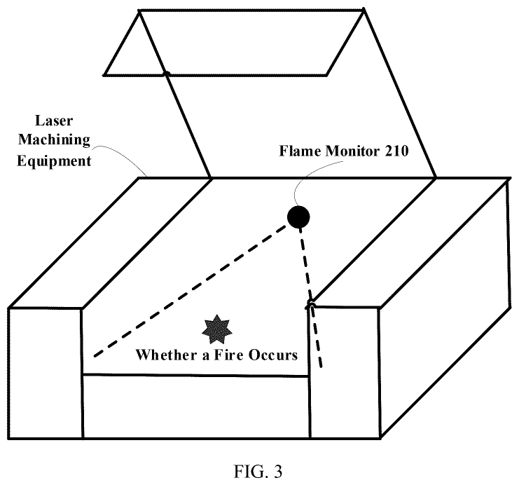

Reference is made to FIG. 3. FIG. 3 shows a schematic diagram of laser machining equipment according to an embodiment of the present disclosure. A cabin of the laser machining equipment is internally configured with a flame monitor 210, where the flame monitor includes a panoramic camera 42 and a processing chip. The cabin is formed by a housing and a cover plate. The panoramic camera 42 is integrated to an upper side in the cabin and is configured to photograph a condition of laser machining performed in the cabin in a full-breadth manner under the coverage of the panoramic camera 42. The processing chip is not designed solely to perform a specific operation, and thus has a capability of processing various control instructions to obtain calculation results and determining whether there is a fire in the cabin.

In other words, the executive process of determining whether there is a fire in the cabin is implemented under the control of the processing chip, without additional configuration of an artificial intelligence (AI)-specific chip. Thus, in order to enable the processing chip to perform flame recognition, an algorithm applicable to the processing chip, such as the flame recognition method provided by the embodiment of the present disclosure, is customized, to ensure that the calculation amount is small and the process can be supported by the operating capacity of the processing chip.

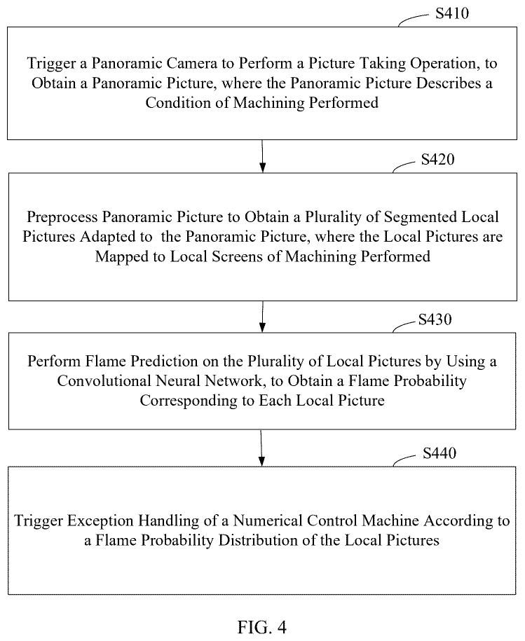

Reference is made to FIG. 4. FIG. 4 shows a flowchart of a flame recognition method for a numerical control machine according to another embodiment of the present disclosure. The method further includes:
step S410: triggering the panoramic camera to perform a picture taking operation, to obtain a panoramic picture, where the panoramic picture describes the condition of machining performed;
step S420: preprocessing the panoramic picture to obtain a plurality of segmented local pictures adapted to the panoramic picture, where the local pictures are mapped to local screens of machining performed;
step S430: performing flame prediction on the plurality of local pictures by using a convolutional neural network, to obtain a flame probability corresponding to each local picture; and
step S440: triggering the exception handling of the numerical control machine according to a flame probability distribution of the local pictures.

These steps are described in detail below.

In the step S410, for the flame recognition, the picture taking operation of the panoramic camera will be first triggered, where the picture taking operation is used to trigger the panoramic camera to photograph field-of-view coverage thereof, to obtain the current condition of laser machining performed by the laser machining equipment. The panoramic camera is integrated to the upper side in the cabin and can photograph a machined material placed in the cabin to capture a screen of the machined material subjected to laser machining currently. It can be understood that if the flames are generated in the current laser machining process, the flames can be inevitably presented on the panoramic picture photographed.

That is to say, the panoramic picture describes the condition of whether there is a fire in laser machining performed currently through picture content. With the progress of laser machining, the conditions for fires caused by materials or various factors often occur but are different, for example, the conditions for the fires include the presence of a small number of flames and flames of large fires.

Thus, it should be understood that the exception handling of the laser machining equipment is triggered when it is monitored that there are the flames in the machining process of the laser machining equipment. Because the conditions for the fires are neither normal nor frequent for operation of the laser machining equipment, the flame monitor can implement flame recognition through a small amount of calculation without real-time detection and a complex algorithm.

In the process of performing a round of detection under the control of the processing chip to complete a current round of flame recognition, the picture taking operation of the panoramic camera is first triggered and performed. The processing chip will trigger a new round of detection according to the set detection interval, to ensure that the occupied computing resources are reduced while the occurrence of the flames can be detected accurately.

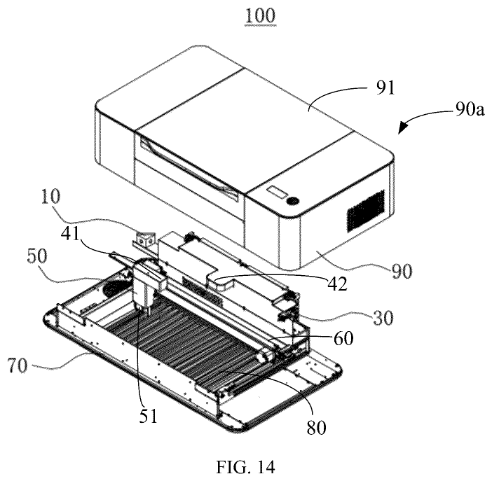

Exemplarily, referring to FIG. 3 and FIG. 14, the laser machining equipment integrates the panoramic camera 42 and a close-range camera 41. The close-range camera 41 is arranged on a movable head 50 (or laser emitter) and can photograph local high-definition images/pictures to update panoramic images/pictures photographed by the panoramic camera for precise machining, positioning, etc. A housing 90a of the laser machining equipment and a cover plate 91 connected to the housing 90a form an internal space in an enclosing manner, that is, the cabin of the laser machining equipment. The cover plate 91 is configured to open and close the cabin. The cabin is internally provided with the movable head 50, a metal cutter, and a track 60 for driving the movable head 50 and/or the metal cutter to slide, where the track 60 may be an X and Y-axis guide rail, and the X and Y-axis guide rail may be a linear guide rail or a guide rail with an optical axis and a roller sliding in cooperation, as long as the movable head 50 can be driven to move on X and Y axes for machining. The laser emitter may be further internally provided with a Z-axis movement track configured to move in a Z-axis direction for focusing before and/or during machining. A bottom in the cabin is used to place a workpiece to be machined. The user can open the cover plate to put the workpiece into the cabin and then close the cover plate, or can open the cover plate to take out the workpiece.

In an embodiment, a laser light source of the laser machining equipment can be generated by the movable head 50. In another embodiment, the laser light source can be generated by another component such as a carbon dioxide laser tube, then enters the laser emitter through a reflector, and finally is emitted by the laser emitter, to machine the workpiece.

During the operation of the laser machining equipment, the panoramic camera is turned on to obtain the panoramic picture, such that a full view of the condition of laser machining in the cabin can be provided to learn whether there are flames in any region and even a flame distribution in a whole region.

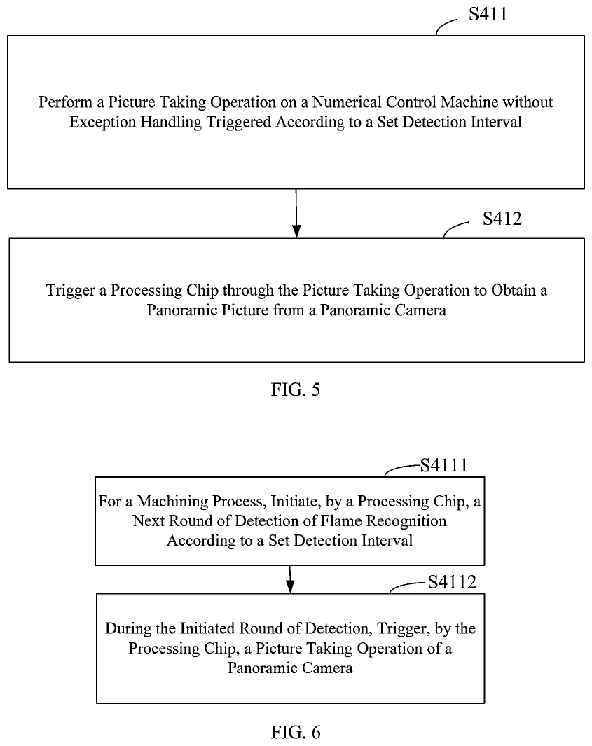

Reference is made to FIG. 5. FIG. 5 shows a flowchart of a flame recognition method for laser machining equipment according to another embodiment of the present disclosure. The step S410 of triggering the panoramic camera to perform a picture taking operation, to obtain a panoramic picture, provided in the embodiment of the present disclosure, includes:
step S411: performing the picture taking operation on the numerical control machine without exception handling t triggered according to a set detection interval; and
step S412: triggering the processing chip through the picture taking operation to obtain the panoramic picture from the panoramic camera.

The two steps are described in detail below.

In the step S411, the processing chip triggers a new round of detection according to the set detection interval, to recognize the flames. With the cooperation of the panoramic camera, a round of detection performed under the control of the processing chip is the whole process of flame recognition. The picture taking of the panoramic camera, the preprocessing of the panoramic picture, and the flame prediction for the local pictures are all performed in a round of detection.

Exemplarily, the set detection interval can be dynamically configured according to a hardware status of the laser machining equipment and the condition of laser machining performed, for example, the detection interval may be 30 s.

The normal operation of the laser machining equipment means that the laser machining equipment does not give a fire alarm and is continuously performing laser machining. During the normal operation of the laser machining equipment, after a round of detection, the processing chip waits for the set detection interval and is triggered again to enter a next round of new detection.

Thus, the flame recognition implemented by the processing chip of the laser machining equipment will be performed at intervals rather than in real time, thereby ensuring that the processing chip can support the process, and adaptively monitoring the conditions for the fires in the laser machining equipment.

In some embodiments, the flame recognition method for a numerical control machine may comprises the above step S310, S320, S330, S411, and S412. After obtain the panoramic picture from the panoramic camera, the method further comprises preprocessing the panoramic picture to obtain a plurality of segmented local pictures adapted to the panoramic picture, where the local pictures are mapped to local screens of machining performed; performing flame prediction on the plurality of local pictures to obtain a flame probability corresponding to each local picture; triggering the exception handling of the numerical control machine according to a flame probability distribution of the local pictures.

In some embodiments, the step S411 further comprises: step S4111, for the machining process, initiating, by the processing chip, a next round of detection of flame recognition according to the set detection interval; and step S4112, during the initiated round of detection, triggering, by the processing chip, the picture taking operation of the panoramic camera. The detailed description of the two steps is as follows.

For example, reference is made to FIG. 6. FIG. 6 shows a flowchart of a flame recognition method for laser machining equipment according to another embodiment of the present disclosure. The step S411 of performing the picture taking operation on the numerical control machine without exception handling triggered according to a set detection interval provided in the embodiment of the present disclosure includes:
step S4111: for the machining process, initiating, by the processing chip, a next round of detection of flame recognition according to the set detection interval; and
step S4112: during the initiated round of detection, triggering, by the processing chip, the picture taking operation of the panoramic camera.

Through the execution of the step S4111 and the step S4112, the next round of detection of the flame recognition for the laser machining equipment can be performed according to the set detection interval, and the processing chip does not perform the flame recognition any more when completing a round of detection, but processes other control instructions, such that the flame recognition can be taken into account and the normal operation of the laser machining equipment can be ensured.

In the step S412, after being triggered by the picture taking operation initiated by the processing chip, the panoramic camera performs a photographing action to generate the panoramic picture. In this case, the processing chip obtains the panoramic picture from the panoramic camera.

In the step S420, after obtaining the panoramic picture, the processing chip preprocesses the panoramic picture to be adapted to input data of the convolutional neural network. The preprocessing process performed includes, but is not limited to, the segmentation performed on the panoramic picture, to obtain the plurality of local pictures, so as to obtain the local screens of laser machining performed through the local pictures.

As pointed out above, the occurrence of the fires, on the one hand, is often due to a small number of the flames in the cabin of the laser machining equipment, which are only distributed on one or a few local pictures; on the other hand, is due to the flames of the large fires, which are distributed on most local pictures. Therefore, it is possible to learn whether the flames are generated in the laser machining process through the obtained local pictures.

As a result, through the preprocessing, on the one hand, a screen description of the generated flames will be provided for the flame recognition to be performed, and on the other hand, data reduced in amount and capable of accurately representing the fires that occurred, i.e., the local pictures are provided for true implementation of the flame recognition, i.e., prediction of the convolutional neural network, and the calculation amount is reduced for deployment and prediction of the convolutional neural network by the processing chip through the local images obtained by preprocessing, such that the processing chip can support the flame recognition function of the laser machining equipment where it is located.

Exemplarily, the preprocessing of the panoramic picture may include scaling down the panoramic picture and then performing a segmentation process. It is ensured that a small number of the flames inside the laser machining equipment are not missing through the description of the panoramic picture, and the data amount and the calculation amount are reduced while the described screen is ensured to be comprehensive, thus enabling normal operation of the processing chip.

Specifically, during the preprocessing performed, the plurality of local pictures are obtained through the scaling-down operation and the segmentation operation on the picture. The obtained local pictures are subjected to secondary scaling-down relative to the panoramic picture, which greatly enhances the availability of the processing chip added with the flame recognition function in the laser machining equipment. The plurality of local pictures mapped to the panoramic picture will also compensate for the accuracy possibly reduced due to this, such that the reliability of the flame recognition function in the laser machining equipment is improved.

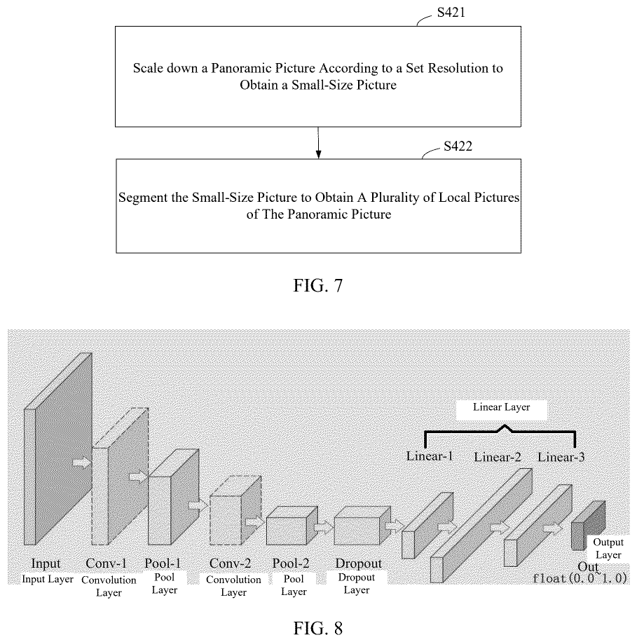

Reference is made to FIG. 7. FIG. 7 shows a flowchart of a flame recognition method for laser machining equipment according to another embodiment of the present disclosure. The step S420 of preprocessing the panoramic picture to obtain a plurality of segmented of local pictures adapted to the panoramic picture, where the local pictures are mapped to local screens of machining performed, provided in the embodiment of the present disclosure, includes:
step S421: scaling down the panoramic picture according to a specified resolution to obtain a small-size picture; and
step S422: segmenting the small-size picture to obtain the plurality of local pictures of the panoramic picture.

The two steps are described in detail below.

For the convolutional neural network, both the step S421 and the step S422 are performed to reduce a data dimension, and parallel execution of the operations is initiated through the plurality of local pictures obtained by segmentation, thereby improving the calculation efficiency while reducing the calculation amount, and reducing the computational burden on the processing chip.

For example, the panoramic picture of 4656*3496 (16 million pixels) is scaled down to obtain the small-size picture of 400*300, and then the small-size picture is segmented to obtain 300 local pictures with a resolution of 20*20.

In the step S430, all the obtained local pictures are used as inputs of the convolutional neural network, and the flame prediction is performed on each local picture, to obtain the flame probability corresponding to each local picture.

Reference is made to FIG. 8. FIG. 8 shows a diagram of a general architecture of a convolutional neural network according to an embodiment of the present disclosure. The system architecture may include an input layer, two convolution layers, two pool layers, a dropout layer, three linear layers, and an out layer.

Exemplarily, as pointed out above, the plurality of local pictures obtained are used as the inputs, and a convolution operation and a pool operation are performed through the convolutional neural network, to extract features of the local pictures and reduce the data amount of the extracted features.

On this basis, another network layer provided by the convolutional neural network, such as the dropout layer, acts on an output of the pool operation performed to ensure the reliability of the convolutional neural network, such that the flame probability can be output for each local picture by the linear layers.

Specifically, network layers, i.e., the convolution layers and the pool layers are combined to obtain two combinations, and the two combinations are superimposed together to form a main architecture of the convolutional neural network, to perform the convolution operation and the pool operation on the input local pictures twice. In other words, the convolutional neural network includes two convolution layers and two pool layers, and the convolution layers are used as initial network layers, where the convolution layers and the pool layers are alternately arranged.

For the convolutional neural network provided with the convolution layers and the pool layers, the dropout layer is connected to an output of a second pool layer, and three linear layers are superimposed on the dropout layer, to establish the complete convolutional neural network.

In this case, the plurality of segmented local pictures are input to a first pool layer, and the corresponding flame probabilities can be output from the linear layers through a plurality of network layers, and so on, to complete the flame prediction of all the local pictures.

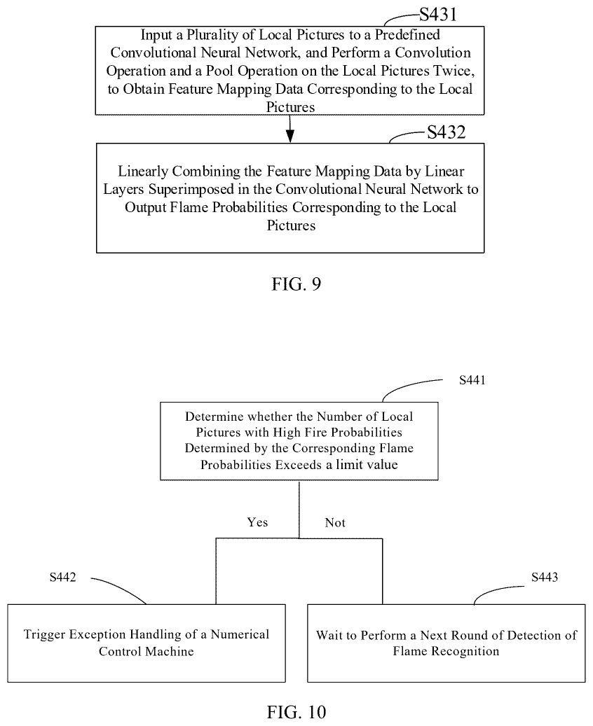

Reference is made to FIG. 9. FIG. 9 shows a flowchart of a flame recognition method for laser machining equipment according to another embodiment of the present disclosure. The step S430 of performing flame prediction on the plurality of local pictures by using a convolutional neural network, to obtain a flame probability corresponding to each local picture, provided in the embodiment of the present disclosure, includes:
step S431: inputting the plurality of local pictures to the predefined convolutional neural network, and performing a convolution operation and a pool operation on the local pictures twice, to obtain feature mapping data corresponding to the local pictures; and
step S432: linearly combining the feature mapping data by linear layers superimposed in the convolutional neural network to output the flame probabilities corresponding to the local pictures.

The two steps are described in detail below.

In the step S431, the plurality of local pictures will be all input to the predefined convolutional neural network and subjected to the convolution operation and the pool operation. Exemplarily, as pointed out above, the plurality of local pictures obtained will all enter the predefined convolutional neural network in which the convolution layers and the pool layers that are distributed alternately provide a possibility for the local pictures to be subjected to the convolution operation and the pool operation twice, and finally the feature mapping data corresponding to the plurality of local pictures is output from the pool layers.

As pointed out above, the predefined convolutional neural network is used to extract the features of the plurality of local pictures, reduce pixels or values mapped by the features, and apply the obtained feature mapping data to the flame prediction to output the flame probability of each local picture. The predefined convolutional neural network includes two convolution layers and two pool layers that are distributed alternately, which implement feature extraction and mapping performed twice.

Specifically, for the convolution operation and the pool operation performed twice, the convolution operation is an operation of calculating a weighted average of a pixel and surrounding pixels thereof, and the pool operation, also known as downsampling, is an operation of reducing the size of the picture. It can be understood that a convolution operation is performed by a convolution layer, and correspondingly, a pool operation may also be performed by a pool layer. Based on this, the convolution operation and the pool operation performed twice refer to that the data corresponding to the local pictures enters the convolution layer and the pool layer twice. The convolution layers and the pool layers interact and overlap with each other, where the convolution layers are used as the initial layers to receive the input local pictures. The convolution layers are used to extract the features of the local pictures, while the pool layers are used to reduce the dimension and reserve the features of the local pictures, to reduce the calculation of the processing chip. The feature mapping data is extracted from the plurality of local pictures by performing the convolution operation and the pool operation. The extracted features are data obtained by mapping for a specific feature dimension. The feature mapping data is data obtained by reducing the mapped pixels or values for the features. In other words, the feature mapping data is a mapping of the extracted features of the local pictures, which will be used to represent screen content of the corresponding local pictures. For example, the feature mapping data can indicate whether there are flames in the local pictures in terms of content.

Each local picture is subjected to feature extraction and feature mapping through the predefined convolutional neural network, and the finally obtained data is reduced through the feature mapping. The availability of the processing chip for numerous control processes and the flame recognition process is ensured under the control of the pool operation performed twice.

In other words, for the execution of fire prediction on the processing chip, the feature extraction and the mapping of the extracted features are repeatedly performed, such that the calculation amount is reduced for the calculation of the flame probability corresponding to each local picture while accurate features are provided, and the processing chip configured only for the laser machining equipment is capable of supporting the operation of the laser machining equipment without configuration of other specific chips, thus fully utilizing hardware resources of the laser machining equipment, and reducing the cost of the laser machining equipment.

In the step S432, the feature mapping data obtained by the convolution operation and the pool operation are used as inputs, and then the flame probability corresponding to each local picture is predicted by the linear layers superimposed in the convolutional neural network. Exemplarily, as pointed out above, the plurality of local pictures obtained will all enter the predefined convolutional neural network, and the feature mapping data obtained by the convolution operation and the pool operation enters the three linear layers in sequence.

The flame probability is a probability of flame occurrence obtained by predicting the feature mapping data of each local picture by the linear layers. The possibility of the flame present on the corresponding local picture can be determined through the flame probability. For example, the larger the flame displayed in the local picture is, the higher the flame probability corresponding to the local picture is, such that the local picture containing the flame can be recognized through the flame probability.

In addition, the predefined convolutional neural network is trained by local pictures corresponding to a large number of panoramic pictures. For a large number of the panoramic pictures photographed in the laser machining process, there are panoramic pictures with flames corresponding to large fires, panoramic pictures without flames, and panoramic pictures with a small number of flames that will be quickly extinguished by themselves. The local pictures are obtained from these panoramic pictures and subjected to annotation processing, such that training data for the convolutional neural network can be obtained.

According to an embodiment of the present invention, the annotation processing on the local pictures refers to that a flame probability corresponding to the local pictures with fires is calibrated to be 1, and a flame probability corresponding to the local pictures without fires is calibrated to be 0.

In the step S440, the flame probability distribution will represent the possibilities of flames at all parts of the panoramic picture. The flame probability distribution indicates whether there are the flames in the cabin and a distribution of the flames, so as to determine whether the exception handling of the numerical control machine is triggered.

Similarly, whether the exception handling is triggered is illustrated using the laser machining equipment as an example in the numerical control machine.

It should be understood that with the flame prediction performed on all the local pictures, the obtained flame probabilities of the local pictures form the flame probability distribution, and then it is determined whether the laser machining equipment is subjected to the exception handling in a round of detection performed currently based on the flame probability distribution.

Specifically, the number of local pictures corresponding to high flame probabilities is obtained from a flame distribution formed by the local pictures, and then it is determined whether there is a fire in the laser machining equipment according to the number of the local pictures with the high flame probabilities. It should be understood that the high flame probability is relative, and a threshold can be configured, such that it can be determined that the flame probability numerically higher than the probability threshold is the high flame probability, otherwise the flame probability is a low flame probability. It should also be understood that a configured limit value for the number of the local pictures with the high flame probabilities is also relative and may also be freely configured, and when the number of the local pictures with the high flame probabilities exceeds the limit value, it can be determined that the fire occurs, otherwise, no fire occurs.

It should be understood that the limit value is preconfigured for the laser machining equipment. Different machines are inevitably configured with different limit values due to their different hardware environments. Exemplarily, the limit value is adapted to a cabin space of the laser machining equipment. Specifically, the adaptation of the limit value to the cabin space refers to a positive correlation between the limit value and a size of the cabin space. For example, if the cabin space is large, the corresponding limit value is configured to be a large value; correspondingly, if the cabin space is small, the corresponding limit value is configured to be a small value. The configured limit value will control the response accuracy of the laser machining equipment to the existing flame.

Relative to a value adapted to a specific cabin space, if the configured limit value is a large value, exception handling is triggered for a fire that has been out of control to cause burnout of the laser machining equipment; and if the configured limit value is a small value, the laser machining equipment gives an alarm for the existing small flame. The presence of the small flame in the laser machining process is extremely normal and does not require intervention. The configuration of the small limit value will affect normal operation of the laser machining equipment, and even make the laser machining equipment unable to operate normally.

In other words, when the cabin space is very large and the limit value is too small, it is likely to trigger the exception handling due to a few sparks generated by the laser machining equipment during machining, while the few sparks will be automatically extinguished, thereby easily causing false triggering; and similarly, when the cabin space is very small and the limit value is too large, it is likely to trigger the exception handling only when the flame is too large, thereby causing damage to the laser machining equipment. Therefore, the limit value must be adapted to the cabin space in which the laser machining equipment performs the laser machining process.

Exemplarily, if the configured probability threshold is 50%, the flame probabilities corresponding to the plurality of local pictures are high flame probabilities when greater than 50%, otherwise, the flame probabilities are low flame probabilities. If the configured limit value for the number of the local pictures with the high flame probabilities is 6, it can be determined that the fire occurs when the number of the local pictures with the high flame probabilities is greater than 6, and the exception handling of the laser machining equipment can be triggered; otherwise, no fire occurs, and the laser machining equipment cannot be triggered to perform the exception handling and will continue to wait for the next round of flame recognition.

Reference is made to FIG. 10. FIG. 10 shows a flowchart of a flame recognition method for laser machining equipment according to another embodiment of the present disclosure. The step S440 of triggering the exception handling of the numerical control machine according to a flame probability distribution of the local pictures in the embodiment of the present disclosure includes:
step S441: determining whether the number of the local pictures with high fire probabilities determined by the corresponding flame probabilities exceeds a limit value, where the limit value is adapted to a cabin space in which the numerical control machine performs the machining process: if it is determined that the number of the local pictures with the high fire probabilities exceeds the limit value, performing step S442, or if it is determined that the number of the local pictures with the high fire probabilities does not exceed the limit value, performing step S443;
step S442: triggering the exception handling of the numerical control machine; and
step S443: waiting to perform the next round of detection of flame recognition.

These steps are described in detail below.

In the step S441, as pointed out above, the local pictures with the high fire probabilities refer to the local pictures corresponding to the high flame probabilities. The high fire probabilities are relative and adapt to the configured probability threshold. In the calculated flame probabilities of the local pictures, it is determined that the flame probabilities corresponding to which local pictures correspond to the high fire probabilities according to the configured probability threshold, and then the number of the local pictures with the high fire probabilities is subjected to statistics.

The number of the local pictures with the high fire probabilities indicates a size of a region with a high fire probability in the flame probability distribution of the local pictures. It should be understood that the wider the coverage of the region with the high fire probability is, the larger the fire in the laser machining equipment is, and the higher the possibility of getting close to loss of control is; correspondingly, the narrower the coverage of the region with the high fire probability is, the more likely it is that there only be flames that will be quickly extinguished in the laser machining process currently performed by the laser machining equipment.

Therefore, the number of the local pictures with the high fire probabilities will indicate whether the fire occurring in the laser machining process currently performed by the laser machining equipment requires intervention. Specifically, it is determined whether the exception handling of the laser machining equipment is triggered according to the determination whether the number of the local pictures with the high fire probabilities obtained through statistics exceeds the limit value, in order to intervene in the current fire.

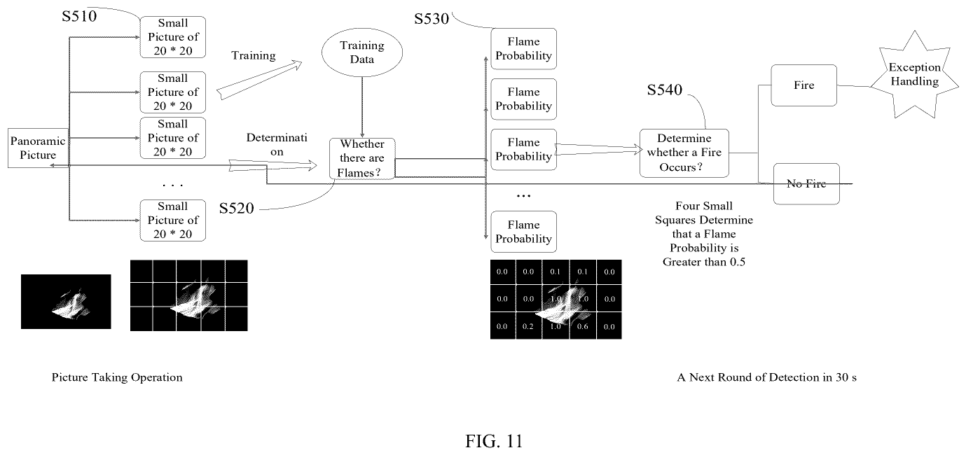

Reference is made to FIG. 11. FIG. 11 shows a flowchart of a flame recognition method for laser machining equipment according to another embodiment of the present disclosure. The plurality of local pictures obtained need to be trained offline before the flame recognition for the machining equipment is completed, to prove that there is no any flame in the machining equipment. In this case, training data obtained through offline training can serve as determination standards, where the training data is obtained according to an actual situation in an offline state. It should be understood that the offline training may be performed only once and may be performed again during subsequent data update. The process includes:
step S510: performing equal-proportion scaling-down processing on a panoramic picture, segmenting a scaled-down picture to obtain a plurality of local pictures with a resolution of 20*20, where the local pictures are mapped to local screens of machining performed;
step S520: determining whether flames are generated in the plurality of local pictures obtained by segmentation according to training data obtained in advance;
step S530: performing flame prediction on the plurality of local pictures by using a convolutional neural network, to obtain a flame probability corresponding to each local picture; and
step S540: determining whether there are the flame probabilities of greater than 0.5 that correspond to four or more local pictures, so as to determine whether exception handling of a numerical control machine is triggered.

These steps are described in detail below.

In the step S510, after obtaining the panoramic picture, the processing chip performs equal-proportion scaling-down on the panoramic picture, where the equal-proportion scaling-down means that a length-width ratio of the panoramic picture remains unchanged. Exemplarily, if a length-width ratio of the panoramic picture is 3:2, then a length-width ratio of the scaled-down picture obtained by scaling-down is also 3:2; or if a length-width ratio of the panoramic picture is 1:1, then a length-width ratio of the scaled-down picture obtained by scaling-down is also 1:1.

The obtained scaled-down picture is segmented to obtain the plurality of local pictures with the resolution of 20*20. It should be understood that the plurality of local pictures obtained by segmentation have the same size. Exemplarily, if the resolution of one of the local pictures obtained by segmentation is 20*20, then the resolution of all the other local pictures is also 20*20.

In the step S520, it is determined whether the flames are generated in the plurality of local pictures obtained by segmentation according to the training data obtained in advance. Data generated by each local picture is compared with the training data obtained by offline training: if the data is the same as the training data, then a flame is not generated in the local picture, or if the data is different from the training data, then there is a possibility of generating a flame in the local picture.

In the step S530, the flame prediction is performed on the plurality of local pictures by using the convolutional neural network, to obtain the flame probability corresponding to each local picture. The flame probability is between 0 and 1, and a specific value may be determined according to a size of the flame in the local picture.

In the step S540, a limit value for the number of the local pictures can be obtained according to empirical data. The original picture is scaled down and segmented to obtain the local pictures with the resolution of 20*20. In this case, the limit value for the number of the local pictures is 4.

If the flame probabilities corresponding to the four or more local pictures are greater than 0.5, the exception handling of the laser machining equipment can be triggered; or if the number of the local pictures with the corresponding flame probabilities of greater than 0.5 is less than 4, the exception handling of the laser machining equipment cannot be triggered, a next round of detection is performed in a few seconds, and the laser machining equipment is re-triggered by the processing chip to perform the picture taking operation of the panoramic camera.

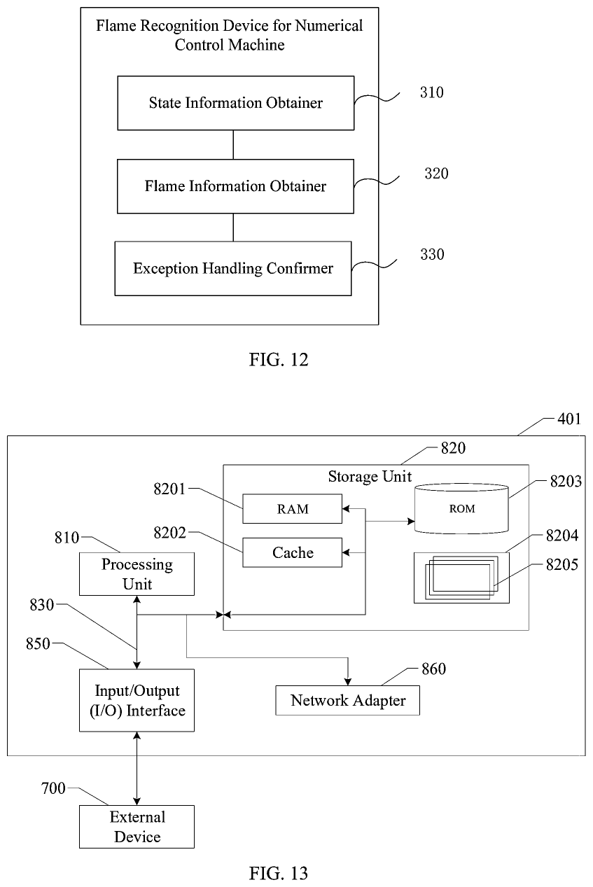

Reference is made to FIG. 12. FIG. 12 shows a block diagram of a flame recognition device for a numerical control machine according to an embodiment of the present disclosure. The flame recognition device for a numerical control machine includes a state information obtainer 310, a flame information obtainer 320, and an exception handling confirmer 330.

The state information obtainer 310 is configured to obtain state information of the numerical control machine, where the state information indicates a condition of machining performed by the numerical control machine.

The flame information obtainer 320 is configured to obtain flame information based on the state information, where the flame information indicates whether flames are generated in a machining process.

The Exception Handling Confirmer 330 is configured to confirm whether exception handling of the numerical control machine is triggered according to the flame information.

In another exemplary embodiment, the flame recognition device for a numerical control machine further includes a picture taking trigger, a preprocessor, a predictor, and an exception handling confirmer.

The picture taking trigger is configured to trigger a panoramic camera to perform a picture taking operation, to obtain a panoramic picture, where the panoramic picture describes a condition of machining performed.

The preprocessor is configured to preprocess the panoramic picture to obtain a plurality of local pictures adapted to segmentation of the panoramic picture, where the local pictures are mapped to local screens of machining performed.

The predictor is configured to perform flame prediction on the plurality of local pictures by using a convolutional neural network, to obtain a flame probability corresponding to each local picture.

The warning device is configured to trigger exception handling of a numerical control machine according to a flame probability distribution of the local pictures.

The flame recognition method for a numerical control machine according to the embodiment of the present disclosure may be implemented by the flame recognition device for a numerical control machine in FIG. 12. The flame recognition device for a numerical control machine according to the embodiment of the present disclosure is described with reference to FIG. 13 below. The flame recognition device for a numerical control machine shown in FIG. 13 is merely an example and should not impose any limitations on the function and scope of application of the embodiment of the present disclosure.

FIG. 14 is a schematic diagram of hardware of the CNC machine according to an embodiment of the present application. As shown in FIG. 14, the CNC machine 100 includes a housing 90a, a movable head 50, a laser tube 30, a close-range camera 41 and a panoramic camera 42 The housing 90a includes a top housing 90 and a bottom housing 70. The close-range camera 41 is arranged on the movable head 50. The CNC machine 100 integrates cameras including but not limited to a panoramic camera for shooting panoramic machining images and the close-range camera 41, and the movable close-range camera 41 is moved to carry out shooting. The panoramic camera 42 is configured to obtain a panoramic image.

A reflecting mirror 10 is arranged between the movable head 50 and the laser tube 30. A laser produced by the laser tube 30 is reflected by the reflecting mirror 10 to the movable head 50 and then is emitted through being reflected, focused and so on to machine workpieces.

The housing of the CNC machine 100, namely the top housing 90 and the bottom housing 70, defines an internal space capable of containing the machined object. To carry out laser machining, the movable head 50, the laser tube 30 and the close-range camera 41 are arranged in the internal space, and the movable head 50 and the close-range camera 41 slide through configured a track 60.

The top housing 90 is further provided with a rotatable cover plate 91. An operator can open up the internal space by opening or closing the cover plate to put in or take workpieces out.

Under the blocking and/or filtering actions of the top housing 90 and the bottom housing 70, the laser emitted by the movable head 50 can be prevented from spilling out to cause personal injuries to the operator during work.

Exemplarily, the internal space can be further internally provided with track 60, and the movable head 50 is installed on the track 60. The track 60 may be X-axis and/or Y-axis guide rails. The X-axis and Y-axis guide rails can adopt guide rails such as linear guide rails or guide rails with smooth shafts and rollers in sliding fit. As long as the movable head 50 can be driven to move on an X-axis and a Y-axis to carry out machining. The movable head 50 can be further internally provided with a Z-axis moving guide rail used for being moved in a Z-axis direction to carry out focusing and machining before machining and/or during machining.

The material bearing platform 80 is used for storing and bearing a processing material in the CNC machine. The panoramic camera 42 and the close-range camera 41 are integrated above the material bearing platform. Because of a restraint of machine dimensions of the CNC machine, the panoramic camera 42 is integrated at a highest location as much as possible. In contrast, the close-range camera 41 is relatively lower than the panoramic camera 42. On the one hand, a view field that the panoramic camera 42 can cover is guaranteed. On the other hand, the mobility of the close-range camera 41 is also guaranteed.

The machined object can be placed at the bottom of the internal space. The user puts the machined object in by opening the cover plate 91, then closes it and can also open the cover plate to take out the machined object.

As shown in FIG. 13, the flame recognition device for a numerical control machine is represented in the form of a general-purpose computing device. Components of the flame recognition device for a numerical control machine may include, but are not limited to, at least one processing unit 810 as described above, at least one storage unit 820 as described above, and a bus 830 connecting different system components (including the storage unit 820 and the processing unit 810).

In an embodiment, one processing unit 810 may be a processing chip or a processor.

The storage unit stores a program code, which may be executed by the processing unit 810, such that the processing unit 810 performs the steps described in the description section of the above exemplary method in this specification according to various exemplary embodiments of the present disclosure. For example, the processing unit 810 may perform the steps as shown in FIG. 2.

The storage unit 820 may include a readable medium in the form of a volatile storage unit, such as a random access memory (RAM) unit 8201 and/or a cache memory unit 8202, and can further optionally include a read-only memory (ROM) unit 8203.

The storage unit 820 may further include a program/utility 8204 having a set (at least one) of program modules 8205. Such program module 8205 includes, but is not limited to, an operating system, one or more applications, other program modules, and program data. Each of these examples or a combination thereof may include implementation of a network environment.

The bus 830 may have one or more of several types of bus structures, and includes a memory unit bus or a memory unit controller, a peripheral bus, a graphics acceleration port, a processing unit, or a local area bus using any of the multiple bus structures.

The flame recognition device for a numerical control machine may be in communication with one or more external devices 700 (such as keyboards, pointing devices, and Bluetooth devices), one or more devices that enable a user to interact with the flame recognition device for a numerical control machine, and/or any devices (such as routers and modems) that enable the flame recognition device for a numerical control machine to be in communication with one or more other computing devices. Such communication may be carried out via an input/output (I/O) interface 650. Moreover, the flame recognition device for a numerical control machine may further be in communication with one or more networks (such as a local area network (LAN), a wide area network (WAN), and/or a public network such as the Internet) via a network adapter 860. It should be understood that while not shown in the figures, other hardware and/or software modules may be used in conjunction with the flame recognition device for a numerical control machine, and include, but are not limited to, microcodes, device drives, redundant processing units, external disk drive arrays, redundant array of independent disks (RAID) systems, tape drives, data backup storage systems, etc.

By the description of the above embodiment, it will be readily understood by those skilled in the art that the exemplary embodiments described herein may be implemented by software or by software in combination with necessary hardware. Therefore, the technical solutions according to the embodiments of the present disclosure may be embodied in the form of a software product that may be stored in a non-volatile storage medium (which may be a compact disc-read only memory (CD-ROM), a USB flash drive, a mobile hard disk, etc.) or on a network and includes a plurality of instructions to cause a computing device (which may be a personal computer, a server, a terminal device, a network device, etc.) to perform the method according to the embodiment of the present disclosure.

In an exemplary embodiment of the present disclosure, there is further provided a computer program medium having a computer-readable instruction stored thereon, where the computer-readable instruction, when executed by a processor of a computer, causes the computer to perform the method described in the above method embodiment section.

According to an embodiment of the present disclosure, there is further provided a program product implementing the method in the above method embodiment, which may be a portable CD-ROM, includes a program code, and may be run on a terminal device such as a personal computer. However, the program product according to the present disclosure is not limited thereto. Herein, the readable storage medium may be any tangible medium containing or storing a program which may be used by or in combination with an instruction execution system, apparatus, or device.

The program product may be any combination of one or more readable media. The readable medium may be a readable signal medium or a readable storage medium. The readable storage medium may be, for example, but not limited to, electric, magnetic, optical, electromagnetic, infrared, or semiconductor systems, apparatuses, or devices, or any combination thereof. More specific examples (a non-exhaustive list) of the readable storage medium include an electrical connection having one or more wires, a portable disk, a hard disk, an RAM, an ROM, an erasable programmable read-only memory (EPROM or flash memory), an optical fiber, a portable CD-ROM, an optical storage device, a magnetic storage device, or any suitable combination thereof.

The computer-readable signal medium may include a data signal propagated in a baseband or as a part of a carrier, the data signal carrying a readable program code. The propagated data signal may be in various forms, including but not limited to an electromagnetic signal, an optical signal, or any suitable combination thereof. The readable signal medium may also be any readable medium other than the readable storage medium. The readable medium can send, propagate, or transmit a program used by or in combination with an instruction execution system, apparatus, or device.

The program code contained in the readable medium may be transmitted by any suitable medium, including but not limited to a wireless medium, a wired medium, a fiber optic cable, a radio frequency (RF), or any suitable combination thereof.

The program code for performing the operation of the present disclosure can be written in any combination of one or more programming languages, where the programming languages include object-oriented programming languages such as Java and C++, and further include conventional procedural programming languages such as “C” language or similar programming languages. The program code may be completely executed on a computing device of a user, partially executed on a device of a user, executed as an independent software package, partially executed on a device of a user and partially executed on a remote computing device, or completely executed on a remote computing device or a server. In the circumstance involving a remote computing device, the remote computing device may be connected to a computing device of a user over any type of network, including an LAN or a WAN, or may be connected to an external computing device (for example, connected over the Internet using an Internet service provider).

It should be noted that while a plurality of modules or units of the device for action execution are mentioned in the detailed description above, such division is not mandatory. In fact, according to the embodiments of the present disclosure, the features and functions of two or more modules or units described above may be embodied in one module or unit. Conversely, the features and functions of one module or unit described above can be optionally divided to be embodied by a plurality of modules or units.

In addition, while the steps of the method in the present disclosure are described in a particular order in the accompanying drawings, it is not required or implied that the steps must be performed in the particular order or that all of the steps shown must be performed in order to achieve a desired result. Additionally or alternatively, some steps may be omitted, multiple steps are combined into one step to be performed, and/or one step is divided into multiple steps to be performed.

By the description of the above embodiment, it will be readily understood by those skilled in the art that the exemplary embodiments described herein may be implemented by software or by software in combination with necessary hardware. Therefore, the technical solutions according to the embodiments of the present disclosure may be embodied in the form of a software product that may be stored in a non-volatile storage medium (which may be a CD-ROM, a USB flash drive, a mobile hard disk, etc.) or on a network and includes a plurality of instructions to cause a computing device (which may be a personal computer, a server, a mobile terminal, a network device, etc.) to perform the method according to the embodiment of the present disclosure.

Other implementation solutions of the present disclosure will readily occur to those skilled in the art upon consideration of the specification and practice of the invention disclosed herein. The present disclosure is intended to cover any variations, uses, or adaptive changes of the present disclosure that follow the general principles of the present disclosure and include common knowledge or customary technical means in the art not disclosed herein. The specification and the embodiments are to be regarded as exemplary only, and the true scope and spirit of the present disclosure are indicated by the appended claims.

What is claimed is:

1. A flame recognition method for a numerical control machine, the numerical control machine being configured with a flame monitor, wherein the method comprises:
obtaining state information of the numerical control machine, wherein the state information indicates a condition of machining performed by the numerical control machine;
obtaining flame information based on the state information, wherein the flame information indicates whether flames are generated in a machining process; and
confirming whether exception handling of the numerical control machine is triggered according to the flame information.

2. The method according to claim 1, wherein the exception handling comprises at least one of giving an alarm, pausing machining, reducing output of electromagnetic energy, blocking emission of the electromagnetic energy, locking a cover of the numerical control machine, stopping an air pump device, and reducing heat output of one or more heating components.

3. The method according to claim 1, wherein the flame monitor comprises a panoramic camera; and the method further comprises:
triggering the panoramic camera to perform a picture taking operation, to obtain a panoramic picture, wherein the panoramic picture comprises information of the condition of machining performed;
preprocessing the panoramic picture to obtain a plurality of segmented local pictures adapted to the panoramic picture, wherein the plurality of segmented local pictures are mapped to local screens of machining performed;
performing flame prediction on the plurality of segmented local pictures by using a convolutional neural network, to obtain a flame probability corresponding to each of the plurality of segmented local pictures; and
triggering the exception handling of the numerical control machine according to a flame probability distribution of the plurality of segmented local pictures.

4. The method according to claim 3, wherein the flame monitor further comprises a processing chip; and triggering the panoramic camera to perform the picture taking operation, to obtain the panoramic picture comprises:
performing the picture taking operation on the numerical control machine without exception handling triggered according to a set detection interval; and
triggering the processing chip through the picture taking operation to obtain the panoramic picture from the panoramic camera.

5. The method according to claim 4, wherein performing the picture taking operation on the numerical control machine without exception handling triggered according to the set detection interval comprises:
for the machining process, initiating, by the processing chip, a next round of detection of flame recognition according to the set detection interval; and
during the initiated round of detection, triggering, by the processing chip, the picture taking operation of the panoramic camera.

6. The method according to claim 3, wherein preprocessing the panoramic picture to obtain the plurality of segmented local pictures adapted to the panoramic picture comprises:
scaling down the panoramic picture according to a set resolution to obtain a small-size picture; and
segmenting the small-size picture to obtain the plurality of segmented local pictures of the panoramic picture.

7. The method according to claim 3, wherein performing flame prediction on the plurality of segmented local pictures by using the convolutional neural network, to obtain the flame probability corresponding to each of the plurality of segmented local pictures comprises:
inputting the plurality of segmented local pictures to a predefined convolutional neural network, and performing a convolution operation and a pool operation on the plurality of segmented local pictures twice, to obtain feature mapping data corresponding to the plurality of segmented local pictures; and
linearly combining the feature mapping data by linear layers superimposed in the convolutional neural network to output flame probabilities corresponding to the plurality of segmented local pictures.

8. The method according to claim 3, wherein triggering the exception handling of the numerical control machine according to the flame probability distribution of the plurality of segmented local pictures comprises:
determining whether a number of the plurality of segmented local pictures with high fire probabilities determined by the corresponding flame probabilities exceeds a limit value, wherein the limit value is adapted to a cabin space in which the numerical control machine performs the machining process; and
if the number of the plurality of segmented local pictures exceeds the limit value, triggering the exception handling of the numerical control machine.

9. The method according to claim 8, wherein triggering the exception handling of the numerical control machine according to the flame probability distribution of the plurality of segmented local pictures further comprises:
if the number of the plurality of segmented local pictures does not exceed the limit value, waiting to perform a next round of detection of flame recognition.

10. The method according to claim 1, wherein the numerical control machine comprises a movable head; at least a part of a machined object is located in a machining space of the numerical control machine; and the movable head is capable of transmitting electromagnetic energy to the machining space, to machine the machined object.

11. The method according to claim 10, wherein the machining the machined object by the movable head comprises:
generating a machining motion plan for the movable head based on a target machining graph;
generating a preview image comprising the target machining graph for expected manufacturing on the machined object; and
transmitting, by the numerical control machine, the electromagnetic energy to the machined object based on the machining motion plan, to change a material of the machined object.

12. The method according to claim 11, wherein the numerical control machine comprises a housing; the machining space is at least partially formed by the housing; the movable head is arranged in the housing; and the housing comprises an openable blocking member capable of weakening transmission of the electromagnetic energy between the machining space and an exterior of the numerical control machine.

13. The method according to claim 12, wherein the numerical control machine comprises at least one camera arranged in the machining space and capable of capturing an image of at least a part of the machined object.

14. A numerical control machine, comprising a housing, a cover plate, a movable head, a track for driving the movable head to slide, a memory, and a processor, wherein the housing and the cover plate form a cabin in an enclosing manner, wherein the movable head, a flame monitor, and the track are arranged inside the cabin, wherein the memory is configured inside the housing and configured to store a readable instruction, wherein the movable head is configured to transmit electromagnetic energy to a machining space; and
wherein the processor in electrical signal connection with the memory reads the readable instruction stored in the memory, to perform a flame recognition method for the numerical control machine, wherein the method comprises:
obtaining state information of the numerical control machine, wherein the state information indicates a condition of machining performed by the numerical control machine;
obtaining flame information based on the state information, wherein the flame information indicates whether flames are generated in a machining process; and
confirming whether exception handling of the numerical control machine is triggered according to the flame information.

15. The numerical control machine according to claim 14, further comprising a processing chip which comprises the processor, wherein the processing chip is configured to perform a first method and a second method, wherein the first method comprises the flame recognition method for the numerical control machine, wherein the second method comprises laser machining methods.

16. The numerical control machine according to claim 14, wherein the numerical control machine comprises at least one camera arranged in the machining space and capable of capturing an image of at least a part of a machined object.

17. The numerical control machine according to claim 14, wherein the flame monitor comprises a panoramic camera; and the method further comprises:
triggering the panoramic camera to perform a picture taking operation, to obtain a panoramic picture, wherein the panoramic picture describes the condition of machining performed;
preprocessing the panoramic picture to obtain a plurality of segmented local pictures adapted to the panoramic picture, wherein the plurality of segmented local pictures are mapped to local screens of machining performed;
performing flame prediction on the plurality of segmented local pictures by using a convolutional neural network, to obtain a flame probability corresponding to each of the plurality of segmented local pictures; and
triggering the exception handling of the numerical control machine according to a flame probability distribution of the plurality of segmented local pictures.

18. The numerical control machine according to claim 17, wherein the flame monitor further comprises a processing chip; and triggering the panoramic camera to perform the picture taking operation, to obtain the panoramic picture comprises:
performing the picture taking operation on the numerical control machine without exception handling triggered according to a set detection interval; and
triggering the processing chip through the picture taking operation to obtain the panoramic picture from the panoramic camera.

19. The numerical control machine according to claim 18, wherein performing the picture taking operation on the numerical control machine without exception handling triggered according to the set detection interval comprises:
for the machining process, initiating, by the processing chip, a next round of detection of flame recognition according to the set detection interval; and
during the initiated round of detection, triggering, by the processing chip, the picture taking operation of the panoramic camera.

20. A non-transitory computer-readable storage medium storing a computer-readable instruction which, when executed by a processor of a computer, causes the computer to perform a flame recognition method for a numerical control machine, wherein the numerical control machine is configured with a flame monitor, and the method comprises:
obtaining state information of the numerical control machine, wherein the state information indicates a condition of machining performed by the numerical control machine;
obtaining flame information based on the state information, wherein the flame information indicates whether flames are generated in a machining process; and
confirming whether exception handling of the numerical control machine is triggered according to the flame information.
